(19) United States
(12) Patent Application Publication
(10) Pub. No.: US 2014/0095618 A1
(43) Pub. Date: Apr. 3, 2014

(54) Social Interaction Device

(71) Applicant: Mind Rocket, Inc., Colorado Springs, CO (US)

(72) Inventors: Michael Charles Larson, Colorado Springs, CO (US); Jesse McClure, Colorado Springs, CO (US)

(21) Appl. No.: 14/044,831

(22) Filed: Oct. 2, 2013

Related U.S. Application Data
(60) Provisional application No. 61/709,134, filed on Oct. 2, 2012.

(51) Int. Cl. H04L 29/06

(52) U.S. Cl. CPC H04L 65/403
USPC 709/204

(57) ABSTRACT

An electronic device, worn like a button, supports and enhances social face-to-face interaction. The electronic button stores information associated with a person's professional and/or personal interests and preferences. This information is continuously broadcast and, when received by another button, analyzed to determine if the receiving and transmitting button possess any commonalities. If a commonality is found, colored light(s) illuminate to let the individuals within the immediate vicinity know a common interest exist. In one version different colored lights can represent different interests.

### RELATED APPLICATION

The present application relates to and claims the benefit of priority to U.S. Provisional Patent Application No. 61/709,134 filed Oct. 2, 2012, which is hereby incorporated by reference in its entirety for all purposes as if fully set forth herein.

### BACKGROUND OF THE INVENTION

1. Field of the Invention

Embodiments of the present invention relate, in general, to social media enabling devices and more particularly to electronic communication means by which to support and enhance social interaction.

2. Relevant Background

The majority of everyday encounters are ephemeral and between strangers. Two strangers may exchange a mutual glance while passing on the street or while going to work on a bus one may initiate a discrete observation. People often identify themselves with non-acquaintances because of their behavior, appearance or age, without an objective reason. In most instances most interactions of this type bear potential to trigger a conversation that might be favored by the persons involved. Unfortunately as often as such interactions may occur many more are missed or avoided due to the lack of a starting point or some realization of a commonality. Knowing that a common interest exist, even if what that common interest is remains undisclosed, can be enough to overcome the barrier of first contact.

No one would dispute that technological advancements have shaped, and will continue to shape, how human beings interact. Consider the impact of the telegraph, telephone, television, facsimile machine, and email have had on day to day human interaction. Today, seamless connectively and communication is so considered the norm that people are often amazed and sometimes frightened when they find they are without access to email out in a cell phone dead zone. Even the vacation industry has recognized the trend and now offers “electronic free” vacations.

But such technological advances come with a cost. Traditional face-to-face interaction, once the primary means of communication, compete with texting, email, and social media pages that are pervasive in today's society. Yet face-to-face interactions play an important role. It provides immediate feedback via non-verbal communication that enables people to adjust their behavior and it is also adaptive to local and dynamic social situations. One study has suggested that 7% of any message is conveyed via words, 38% through certain vocal elements and 55% via nonverbal elements such as facial expression, gesture and posture. Regardless of the accuracy of these numbers, it appears clear that a large portion of communication lies as much in how something is said as it does in what is said. So despite the advantages that technology has brought to the daily challenges of information dissemination, it has in some sense hindered or de-emphasized face-to-face interaction.

Cell phones, smart phones, tablets and the like continue to improve and be more and more common. A need therefore exists to utilize telecommunication technology to support and assist interpersonal communication rather than hinder or de-emphasize it. One or more embodiments of the present invention provide a social interaction device and associated methodology that promotes and encourages face-to-face interaction overcoming the first contact barrier.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

Disclosed hereafter by way of example is an electronic device, worn like a button, that supports and enhances social interaction. The electronic button stores information associated with a person's professional and/or personal interests. This information is continuously broadcast and, when received by another button, analyzed to determine if the receiving and transmitting button possess any commonalities. If a commonality is found, colored lights in one embodiment flash to let the individuals wearing the buttons know some level of common interest exists. In one version different colored lights can represent different interests.

The social interaction devices of the present invention are devices that identify matches in personal preferences shared by two or more users. The device wirelessly scans the vicinity for other like buttons. According to one embodiment of the present invention, when two buttons establish a data link they exchange information via a wireless signal, e.g., infrared, WiFi, Bluetooth, etc. An on-board algorithm compares data stored in the button's memory with the data sent from the other button to determine whether any correlation in the data exists, either in a particular or a composite way, for the various categories. When a correlation occurs the buttons light up to indicate a match. In other embodiments of the present invention the lights can be combined with an audible tone or vibration mechanism; the preferred method being by illuminating diodes built into the button in colors corresponding to the specific matching areas or a percentage or representation of a degree of correlation. For example, a red diode may correspond to matches in relationship preferences, blue to matches in professional preferences, and green to matches in leisure preferences, and two people meet wearing buttons that register matches in all three of these areas, both buttons will begin to glow alternately red, blue and green to signify multiple matches.

One vision of the present invention uses a client/server relationship in which users input their preference data into a software program, webpage, or mobile app that is compiled by the server. After completing the profile, which can be customized to include a variety of data categories, the information is uploaded wirelessly to the button by way of a peripheral plugged into the computer or mobile device. The peripheral base station contains a transmitter and receiver compatible with those in the button. Once the data is entered into the profile, the profile and associated data is uploaded to the button and the button thereafter is autonomous.

Each button broadcasts data with respect to the host's interests and preferences and simultaneously receives data from other nearby buttons. Received data is processed by an onboard correlation engine. Once a correlation has been determined the lights on the host button illuminate indicating a match has been detected. As the illumination of lights is observed others in the vicinity can conclude that they share a common interest and initiate a face-to-face interaction.

According to another embodiment of the present invention a server collects data from a variety of users regarding preferences, likes and interests and, as before, associates the data as individual user profiles with a particular button or button identification. In this embodiment the server processes the data to determine correlations or matches between the various user profiles and conveys to each button matching information. Once the data has been downloaded to each social interaction device, the devices themselves simply search out and identify matching identification numbers rather than internally determining if a correlation or match exists. Each button transmits its own identification number and receives the identification numbers of other buttons within range. Upon receiving an identification number listed as a match, the button illuminates the appropriate light or set of lights.

A method of social interaction using a social interaction device is yet another embodiment of the present invention. Such methodology includes inputting, by each user, information with respect to interests, personal preferences, goals, educational background, etc. The information, in one embodiment of the present invention, is associated with a user profile. That profile identification is further linked to a particular social interaction device. A correlation engine processes the data from each user to determine either individualistic matches or a degree of correlation. Once a match or predefined level of correlation has been achieved between user profiles a correlation list can be sent to each social interaction device. Once updated, each device maintains a list of other devices that possess a certain degree of correlation. Upon receiving information that a matching device is within range, the receiving device can display a corresponding illumination of lights reflective of the degree of correlation.

The description with reference to the drawings that follows provides an understanding of exemplary embodiments of the present invention. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 is an exemplary social environment in which face-to-face interaction between one or more users is enhanced through use of one embodiment of the social interaction device of the present invention;

FIG. 2 is an exemplary questionnaire used in conjunction with a social interaction device of the present invention;

FIG. 3 shows a exemplary user preference table used in conjunction with a social interaction device of the present invention;

FIG. 4 is a high level block diagram of a social interaction device system indicating a server/client relationship according to one embodiment of the present invention;

FIG. 5 is a high level block diagram of a social interaction device according to one embodiment of the present invention;

FIG. 6 is a schematic of intersection antenna patterns associated with a plurality of social interaction devices according to one embodiment of the present invention; and

FIG. 7 is a flow chart of one method embodiment for social interacting using a plurality of social interaction devices according to one embodiment of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

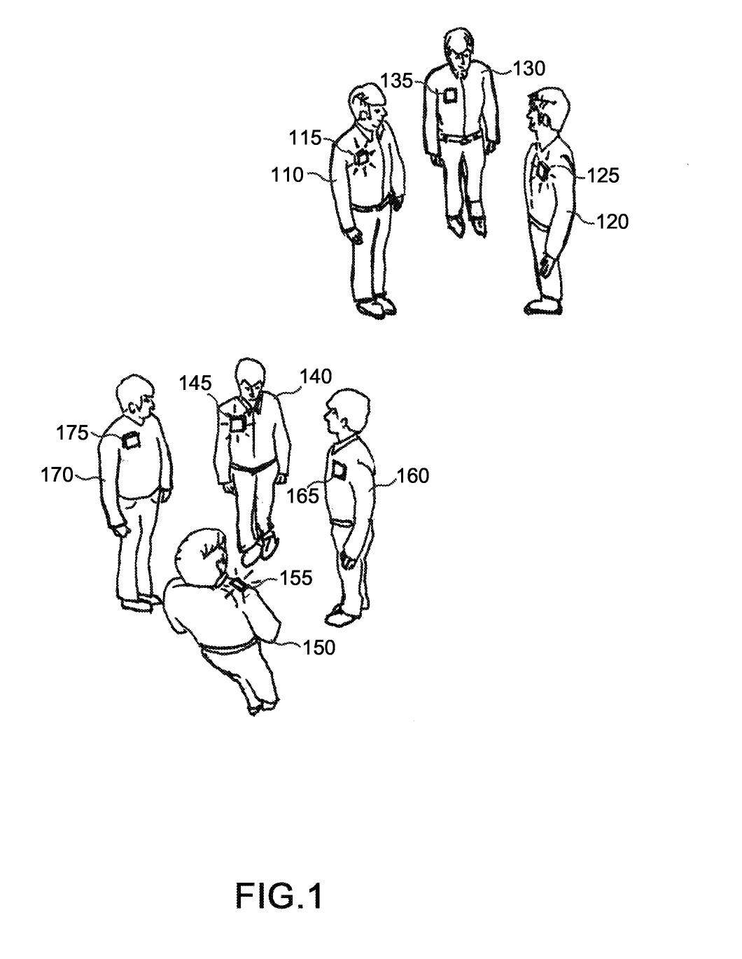

Face-to-face interaction is enhanced by a social interaction device that identifies and communicates the presence of user commonalities. One or more embodiments of the present invention present a social interaction device that provides users with visual feedback when another nearby user shares certain common interests or preferences. FIG. 1 provides a high level depiction of social environment in which the interaction of a plurality of individuals is enhanced by one embodiment of the social interaction device of the present invention.

FIG. 1 shows an environment in which a plurality of users are each equipped with a social interaction device of the present invention. As will be subsequently described, each user has provided information with respect to certain individual characteristics, likes, dislikes, preferences and the like. This information is individually associated with a user profile and ultimately with a social interaction device. The device can be, as is shown in FIG. 1, an object that can be worn on a person's article of clothing. Moreover, the device, in one embodiment, provides a light or similar output display unit that can be seen by other nearby individuals when the social interact device determines that two individuals share a common interest or preference. As introduced above and explained in more detail below, each user or individual is associated with a single device. Each user is associated with a unique social interaction device that, in turn, interacts with other social interaction devices to ultimately promote face-to-face interaction between the associated users.

In FIG. 1 seven individuals 110, 120, 130, 140, 150, 160, 180 are interacting in a social setting. Assume that all of these individuals are in the same room and, while, perhaps not directly interacting, there are no physical barriers such as walls that would prevent such interaction. Each individual possesses and wears a social interaction device of the present invention. The device provides direct and immediate feedback that an individual (or more accurately another device associated with an individual) within its proximity possesses a shared interest, preference or some other commonality.

For example in upper right corner of FIG. 1 three individuals 110, 120, 130 are interacting. Each wears a social interaction device which, in this embodiment of the present invention, is a button 115, 125, 135 worn on an article of clothing. The system and methodology of the present invention determine that two of the three individuals 110, 120 share some sort of commonality. As these two individuals come within proximity of each other their respective devices provide some sort of output. In this case, a light, visible by others, on the social interaction devices illuminates. Thus lights on the social interaction device 115 for the first individual 110 and lights on the social interaction device 125 of the second individual 120 illuminate while the social interaction device of the third individual 130 remains dormant.

Similarly, two individuals in the lower interactive group 140, 150 also share a commonality. As they are in proximity of each other their devices 145, 155 illuminate while the social interaction devices 175, 165 of the other two individuals 160, 170 remain dormant. As will be discussed in the following description the devices work on a line-of-sight basis and over a limited range to encourage face-to-face and interpersonal interaction. And while in this example the lights associated with the social interaction device of some individuals did not illuminate, it is entirely possible that as the individuals interact and change position they too will identify others in the room that possess a common interest, preference, etc.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will also be understood that when an element is referred to as being “on,” “attached” to, “connected” to, “coupled” with, “contacting,” “mounted,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with, or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

A system and device for enhanced social interaction is hereafter described by way of example. The advances in technology, especially telecommunication technology, have, to some degree, deterred direct social interaction. Yet our thirst for timely and accurate information drives many technology sectors to provide immediate and seemingly effortless ability to communicate, interact, and share information. Where once social gatherings were the means to exchange information and explore interpersonal connections, today text messages, voice mail, email, social media and the like replace our direct day-to-day interaction. While the speed and immediacy of communication has accelerated, individual and direct, face-to-face interaction has decreased. The present invention uses computing and telecommunication technology to enhance and encourage social, face-to-face communication by giving individuals immediate visual feedback that they share a common interest.

According to one embodiment of the present invention a social interaction device worn by an individual provides an output indicating another individual within the immediate vicinity shares a common interest. The social interaction device system of the present invention includes a plurality of social interaction devices utilizing a client/server relationship. Each device is associated with a single user and each user presents information about themselves to form a user profile. The user provides information about their preferences, characteristics, goals, likes and dislikes, etc. that is collected and used as the basis to determine matches or correlations with other users.

In one embodiment a computer, server or similar processing capability is used to collect the information and determine whether there are any commonalities or correlations in the information. One skilled in the relevant art will appreciate that such a correlation process can be efficiently conducted using a computer or similar processing technology. For example the present invention may be implemented on a conventional or general-purpose computer system, such as an personal computer (PC), a laptop computer, a notebook computer, a handheld or pocket computer, and/or a server computer. Such a computer typically comprises a central processing unit(s) (CPU) or processor(s) coupled to a random-access memory (RAM), a read-only memory (ROM), a keyboard, a printer, a pointing device, a display or video adapter connected to a display device, a removable (mass) storage device (e.g., disk, CD-ROM, CD-R, CD-RW, DVD, or the like), a fixed (mass) storage device (e.g., hard disk), a communication (COMM) port(s) or interface(s), a modem, and a network interface card (NIC) or controller (e.g., Ethernet).

The CPU comprises a suitable processor for implementing portions of the present invention. The CPU communicates with other components of the system via a bi-directional system bus (including any necessary input/output (I/O) controller circuitry and other logic). The bus, which includes address lines for addressing system memory, provides data transfer between and among the various components. Random-access memory serves as the working memory for the CPU. The read-only memory (ROM) contains the basic input/output system code (BIOS)—a set of low-level routines in the ROM that application programs and the operating systems can use to interact with the hardware, including reading characters from the keyboard, outputting characters to printers, and so forth.

Mass storage devices provide persistent storage on fixed and removable media, such as magnetic, optical, or magnetic-optical storage systems, flash memory, or any other available mass storage technology. The mass storage may be shared on a network, or it may be a dedicated mass storage. Such mass storage can store a body of program and data for directing operation of the computer system, including an operating system, user application programs, driver and other support files, as well as other data files of all sorts. Typically, the fixed storage serves as the main hard disk for the system.

In basic operation, program logic (including that which implements methodology of the present invention described below) is loaded from the removable storage or fixed storage into the main (RAM) memory for execution by the CPU. During operation of the program logic, the system 500 accepts user input from a keyboard and pointing device, as well as speech-based input from a voice recognition system (not shown). The keyboard permits selection of application programs, entry of keyboard-based input or data, and selection and manipulation of individual data objects displayed on the screen or display device. Likewise, the pointing device, such as a mouse, track ball, pen device, or the like, permits selection and manipulation of objects on the display device. In this manner, these input devices support manual user input for any process running on the system.

Such a computer system itself can communicate with other devices (e.g., other computers) via the network interface card (NIC) connected to a network (e.g., Ethernet network, Bluetooth wireless network, or the like), and/or modem (e.g., 56K baud, ISDN, DSL, or cable modem). The system may also communicate with local occasionally-connected devices (e.g., serial cable-linked devices) via the communication (COMM) interface, which may include a Universal Serial Bus (USB) interface, or the like. Devices that will be commonly connected locally to the interface include laptop computers, handheld organizers, digital cameras, and the like including the social interaction device of the present invention.

Moreover, portions of the present invention can be implemented in software. Software programming code that embodies one or more portions of the present invention is typically accessed by a microprocessor from long-term, persistent storage media of some type, such as a flash drive or hard drive. The software programming code may be embodied on any of a variety of known media for use with a data processing system, such as a diskette, hard drive, or CD-ROM. Alternatively, the processing instructions can be embodied in firmware or even hardware. The code may be also distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures, and the like that perform particular tasks or implement particular abstract data types. Moreover, those skilled in the art will appreciate that the invention can be practiced with other computer system configurations, including hand-held devices, smart phones, multi-processor systems, microprocessor-based or programmable consumer electronics, network PCs, minicomputers, tablets, mainframe computers and the like. The invention may also be practiced in distributed computing environments where tasks are performed by remote processing devices that are linked through a communications network. In a distributed computing environment, program modules may be located in both local and remote memory storage devices.

The social media device of the present invention utilizes these resources to identify and, in one embodiment, visually indicate when individuals sharing common interests are in the immediate vicinity of each other. As previously discussed, each user submits information regarding their likes, dislikes and interests. These data points can be personal and/or professional in nature. They can be broad in scope or be tailored to address interests within a specific subgroup. Once data is collected from a plurality of individuals, the system of the present invention analyzes the data to identify correlations and commonalities in interests. Matching and correlation algorithms provide an indication based on the input data that certain individual share common interests, likes or dislikes. For example, the system may conclude that group of individuals prefer outdoor activities awhile another prefer the solitude of the home. Interests in travel can be identified as can positions with respect to professional activities.

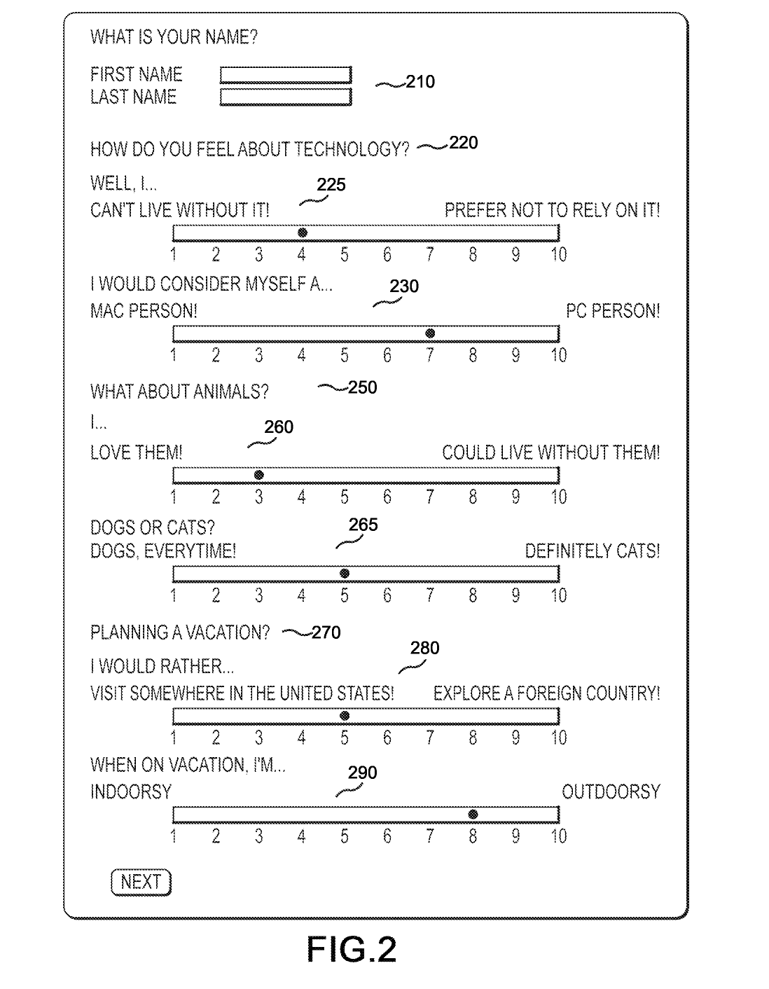

Consider the example questionnaire illustrated in FIG. 2. This questionnaire inquires a user's position on three basic topics, technology 220, animals 250 and vacation 270. After associating the questionnaire with the user's name 210 the questionnaire in this embodiment allows the user to indicate on a scale of 210 their position with respect to these topics. For example with respect to technology 220 the system asks the user whether they embrace technology or prefer not to rely on it 225. And then it seeks more granular detail by asking them to distinguish themselves between being a Mac person or a PC person 230.

Similarly, the questionnaire of FIG. 2 seeks information about animals 250 by first asking the user if they love animals or could live without them 260. And then their preference between cats and dogs 265. With respect to a vacation 270 the inquiry asks the user to pick between visiting somewhere in their native country 280 or exploring a foreign country. And then lastly, whether the user considers themselves more of an indoor person or an outdoor person 290.

According to one embodiment of the present invention, all of the users in a particular group interaction are provided with and respond to the same questionnaire or inquiry. In other embodiments of the present invention, information regarding interests, likes, dislikes etc. can be gained by other sources and used as a basis to find a commonality. But in this example, each of the users are presented and complete the questionnaire of FIG. 2. The present invention associates each set of data presented by a user with a user profile and associates that profile with a unique social interaction device. Each social interaction device includes a social interaction device identification number.

A correlation engine identifies correlations and commonalities in personal preferences. By assigning a value to each question and to each answer, a matrix of user preferences can be established. These preferences can then be compared on a user basis to see if any particular users share a common interest. For example, assume for the purpose of the present example that the two questions with respect to vacation 270 from FIG. 2 have a range of scores from 0 to 20. Each question, (whether the user would prefer explore domestically or abroad and whether they are an indoor or outdoor person) can be scaled from 0-10 resulting in a total point scale of 0-20. In this instance a person that strongly prefers to vacation domestically and do so indoors would have 0 points while another user indicating their strong desire to travel abroad and be outdoors would have 20 points.

In one embodiment of the present invention, a predefined set of correlation parameters determines whether there is a match. The system can, in one embodiment set defined commonalities point values of 0-5, 6-10, 11-15 and 16-20. Users that have those common point values for the topic of “vacation” 270 would be listed as a match. The reader will appreciate that in this simple example the questions are purposely vague. Clearly, one individual may have completely different understandings of what it means to be an “outdoor” person or the extent to which they may wish to travel abroad. But it does identify a general common area of interest that can be the basis of further interpersonal interaction.

Consider in this example that a group of 15 individuals completed the questionnaire. Four of the individuals under the category of vacation scored in the range of 16-20 points indicating a preference to travel abroad and be outdoors. The present invention uses this information to convey to these individuals that they may share a common interest so as to encourage face-to-face interaction.

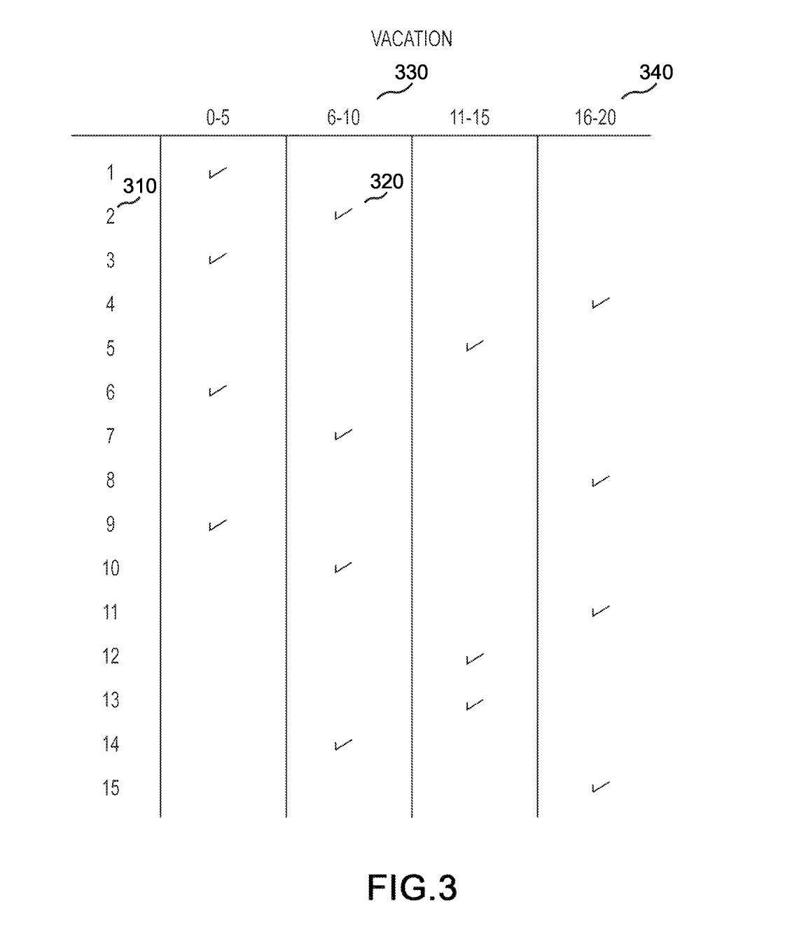

One embodiment of the present invention accomplishes this task by developing a correlation list of matching profiles. FIG. 3 presents, according to one embodiment of the present invention, a simplified matrix regarding user preferences. In this example, the compiled score for the category vacation are listed for each user under four predefined ranges. One of reasonable skill in the relevant art will appreciate that the sophistication of the matching algorithms and correlation processes may vary widely but each is within the scope, and is indeed contemplated by the present invention. Indeed the questionnaire and user profile data can be very simple as illustrated herein or can be very complex and detailed. So too can the process by which a correlation or match is determined. All of which are contemplated as to be within the scope of the present invention.

FIG. 3 illustrates the combined vacation score for each user. For example, user number 2 310 has a vacation score of 8 320 which places that user in the second range 330 of 6-10 points. Examination of FIG. 3 will show that several users share or are common to a particular vacation score range. For example, users 4, 8 11, and 15 are all associated with a vacation score that lies within the 16-20 point range 340.

Accordingly to one embodiment of the present invention a correlation or match list is created for each user and for each particular area of interest. Continuing with the example above, users 4, 8, 11 and 15 share a common preference with respect to vacation. Thus, the system would create a match list for each user of the indicated user matches. The list for user 4, for example, under the category of vacation preference, would be user 8, 11 and 15. Likewise, the match list for user 8 would list users 4, 11 and 15.

In the same fashion, the present invention creates correlation lists for each user and for each area of interests. In this example there are three areas of interest; technology, animals and vacation. So each user profile will have associated with it three lists of users that share their preferences.

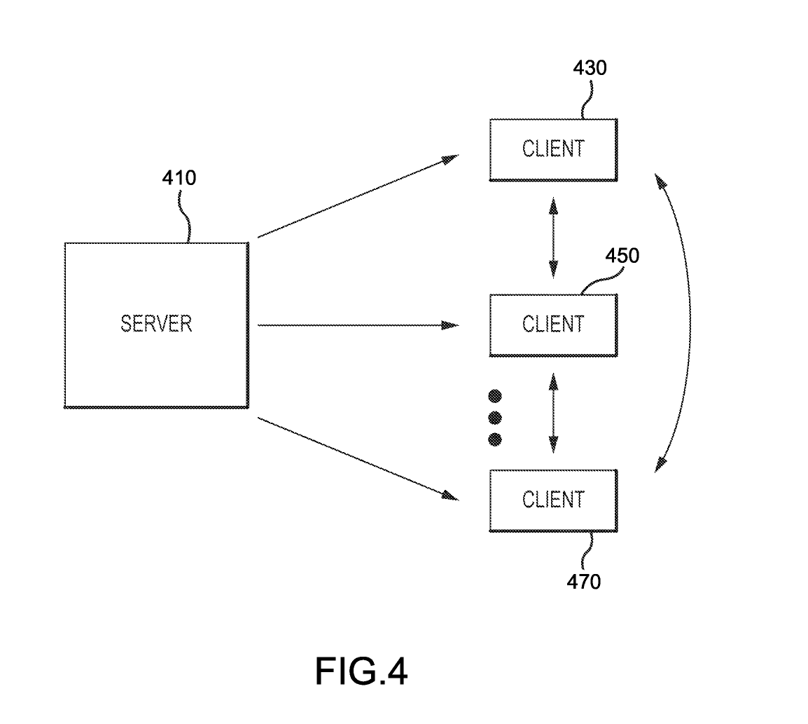

The present invention conveys this information visually using a social interaction device. FIG. 4 presents a high-level block diagram of a server/client relationship used by one embodiment of the present invention. As shown a server 410 proves each social interaction device (client) 430, 450, 470 with certain data. Thereafter each client 430, 450, 470 interacts based on that data to provide the users with an indication of commonalities.

According to one embodiment each user is associated with an individual and unique social interaction device. Each device includes a social interaction device identification number. As the server collects information and determines preference matches between users it develops a series of lists as demonstrated above. According to one embodiment of the present invention, each user is provided with a list of matching social interaction device identification numbers. Referring back to the example above user 4 was identified to have a commonality of vacation preferences with users 8, 11 and 15. Each of these users is also associated with a unique social interaction device that has its own social interaction device identification number. The server 410 communicates, and the social interaction device 430, 450, 470 accepts, an individualistic list of matches.

Accordingly, the social interaction device associated with each user receives and stores on the social interaction device a match list for each area of interest. Therefore, in this example, each social interaction device would receive from the server three lists of matches. A list for other social interaction devices that match that user's preferences each for technology, animals and vacations.

Once programmed or updated with the lists of matching social interaction devices, the user wears the device as a button. As described below, each button broadcasts its own identification number as well as receives those from nearby devices. When the device receives a social interaction device identification number that matches an identification number on one of its stored lists, the device initiates an output that can alert other nearby users that a commonality exists.

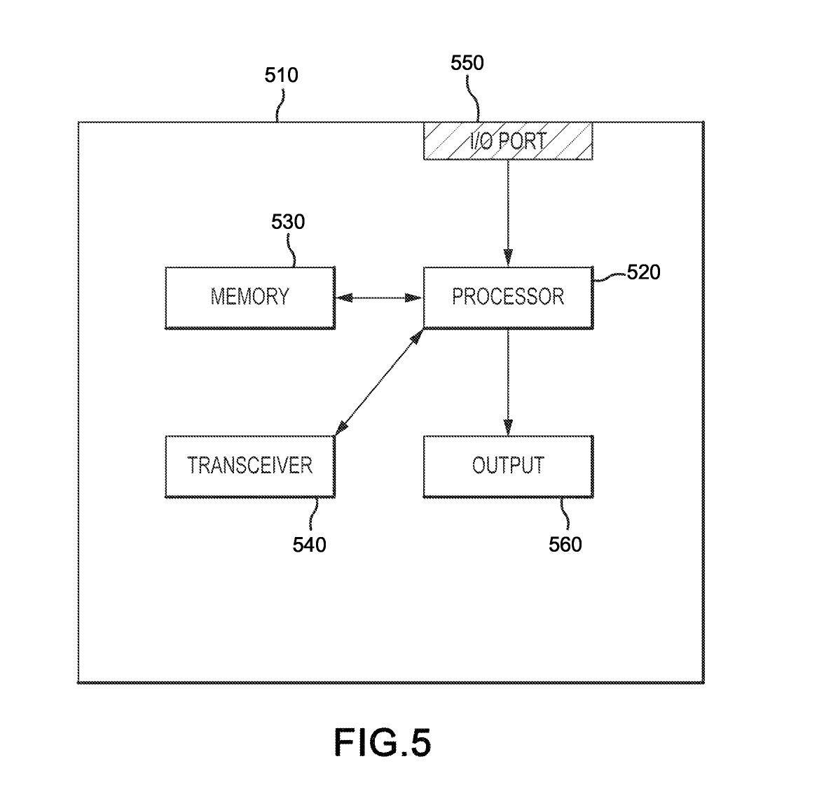

FIG. 5 provides a high level block diagram for a social interaction device according to one embodiment of the present invention. The social interaction device 510 is a self-contained computational environment that includes, among other things, a microprocessor 520, non-volatile memory 530, a transceiver 540, a communication port 550 and an output module 560. One of reasonable skill in the relevant art will appreciate that the social interaction device 510 may include other components necessary for functionality, including a power source, antenna, buses, etc.

In one embodiment of the present invention each social interaction device 510 is communicatively coupled to a server of the social interaction device system whereby a correlation list or lists are downloaded from the server and stored in the memory 530 of the device. The memory can, in one embodiment, include code to access the list and compare the data included to that collected by the device itself.

In operation, users include the social interaction device as a button that may be displayed as a button on an article of clothing or hanging on a lanyard such as a locket. The device is personalized to each user and contains the correlation or match lists pertinent for that user. As one of reasonable skill in the relevant art will appreciate, the button/locket of the present example can be implemented by a variety of means. The social interaction device, and indeed the terminology itself, should not be interpreted as limiting as to a button or other physical rendering. The present invention contemplates a means by which face-to-face interaction of individuals can be enhanced using concepts presented herein. The social interaction device can be wearable accessory such as a brooch, belt buckle, jewelry, clothing, and the like that is visible by others.

The transceiver 540 of each social interaction device 510 broadcasts its identification number while simultaneously receiving the identification numbers of any other social interaction devices within its proximity. According to one amendment of the present invention, each social interaction device transceiver transmits and receives data using infrared signals. Other forms of communication known to one of reasonable skill in the relevant art can be utilized by and are contemplated by the social interaction device.

One of reasonable skill will also recognize that infrared signals are limited to line of sight transmission of data. According to one embodiment of the present invention the social interaction devices, and presumably the users displaying such devices, must be within a direct line-of-sight for the two devices to share data. Moreover, one embodiment of the present invention limits the infrared transceiver antenna pattern to be forward looking and receiving so as to maximize the visual impact of two devices recognizing that their associated user's share a common interest.

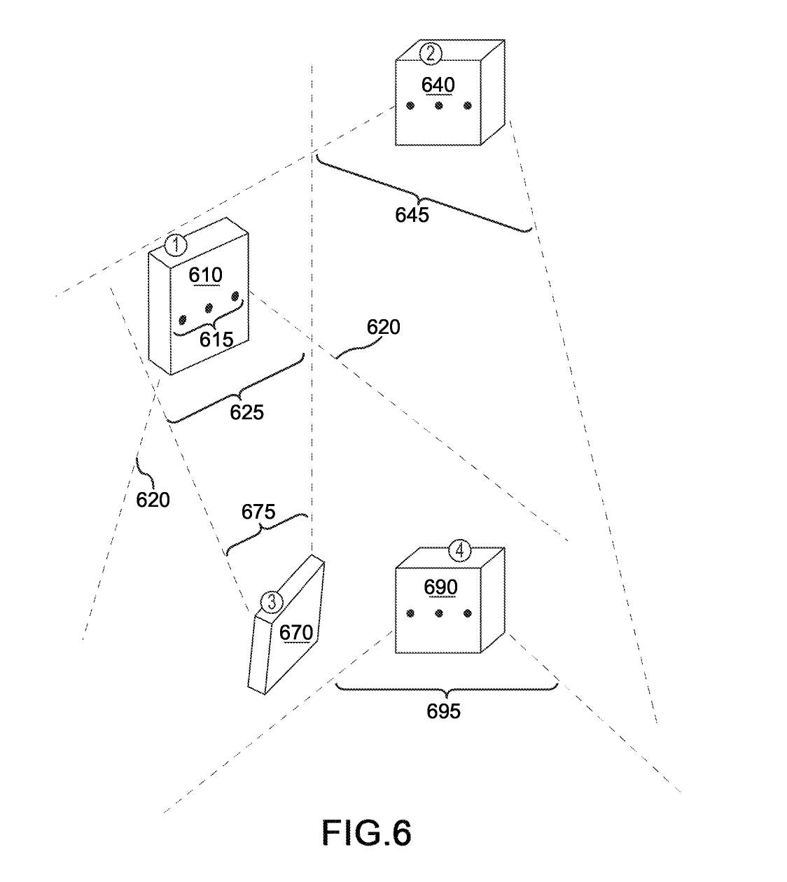

FIG. 6 illustrates an environment of interaction between a plurality of social interaction devices according to one embodiment of the present invention. In the example environment shown in FIG. 5, four social interaction devices 610, 640, 670, 690 are oriented in different directions in a common area. In this example, there are no walls or objects interfering with the transmission or reception of signals, however, one of reasonable skill in the telecommunication art will recognize that an object, wall, obstacle or even individual would be opaque to and thus blocking of infrared signals. In addition, each device includes three outwardly visible light sources 615 of varied colors that can be illuminated upon meeting certain predefined criteria.

In FIG. 6, each device includes an angular antenna radiation pattern emanating from the antenna which is generally on the front of the device. In the field of antenna design the term radiation pattern (or antenna pattern) refers to the directional (angular) dependence of the strength of the electromagnetic waves from the antenna or other source. These shapes vary widely and a full discussion of how they vary is beyond the scope of this discussion. However, the present invention is based on data conveyed between devices when two such antenna patterns interact. For example device 1 610 includes an antenna pattern roughly identified by two guide lines 620 originating from the device and extending outward with an approximate 70 degree angle. In one embodiment the range of such an antenna pattern is approximately 7 meters. The lines represent a three dimensional cone and while the depiction in FIG. 6 shows linearity in the antenna pattern, one skilled in the relevant art will recognize that the true antenna pattern varies in a non-linear manner.

In one embodiment of the present invention, the antenna for transmission of a social interaction device's identification number and reception of the identification numbers from other nearby social interaction devices is coincident. In other embodiments, the reception and transmission antenna patterns may vary based on the desired use of and outcome from the social interaction device system.

One can also appreciate the directional nature of the antenna patterns by considering the intersection nature of the antenna pattern shown in FIG. 6. In this example, the antenna pattern 645 for social interaction device 2 640 encompasses each of the other three devices. Presumably, if each of the other devices include an omnidirectional receiver they could each receive the social interaction device identification number of device 2 640 as it broadcasts. However, as each receiver antenna pattern for the other devices 610, 670, 690 is, in this example, constrained to match its transmission pattern 625, 675, 695 respectively, none of the other devices shown in FIG. 5 is aware of the presence of device 2 640. Similarly, device 4 690 has no understanding that other devices are in the environment.

The antenna patterns of two social interaction devices in FIG. 6 are oriented so as to interact. Social interaction device 1 610 and social interaction device 3 670 are oriented toward each other such that their respective antenna patterns 625, 675 intersect. Social interaction device 1 610 can receive the social identification number broadcast by social interaction device 3 670 and likewise, social interaction device 3 670 can receive the social interaction device identification number of device 1 610. Recall that each social interaction device possesses a stored correlation list of the identification numbers of social interaction devices that are associated with users that have the same preferences.

Accordingly to one embodiment of the present invention, upon receiving the identification number of another nearby social interaction device, the receiving device compares the received identification number to its stored lists. If no match is found the device does not reach. However, if upon accessing the correlation list the received interaction device identification number matches an identification number on the list, the receiving social interaction device initiates a response. According to one embodiment of the present invention, the response can be the illumination of a specific light that can be outwardly observed. As long as the two devices remain within each other's antenna pattern the indicated output will continue.

Consider the following example. Assume that device 1 610 of FIG. 6 is associated with user 4 of FIG. 3 and that device 3 670 is associated with user 15. Each device 610, 670 has received from the server, and has stored within its memory, a correlation list for vacation preferences. Thus, the list stored in device 1 610 includes the social interaction device identification number of device 3 670 and conversely the correlation list stored in device 3 670 includes the social interaction device identification number of device 1 610.

As the two devices 610, 670 come within range of each other they receive the broadcast identification number of the other device. Both devices compare the received identification number to their stored lists and determine, in this case, a match exists. According to a predefined output protocol, when a match for vacation preferences exists, each devices' output module will illuminate one of the three lights 615 that is outwardly visible. In this case, assume that the predefined output protocol calls for the illumination of a green light so long as the match exists. In other embodiments, the light may be illuminated for a certain period of time measured from when the match is first discovered.

In this example, as the antenna pattern of each social interaction devices intersect, each device will independently determine that the other device is a match resulting in the illumination of, in one example, the green light. Since the transceivers use infrared technology (or similar line of sight communication means) the devices (or at least their antenna) must be visible to each other so presumably the illumination of a light also associated with each device will be visible by each user. As described above each device includes a transceiver that transmits and receives data. In one embodiment that data is conveyed via infrared signals. As the infrared antenna patterns for the devices intersect data is exchanged and the devices can determine whether an appropriate output should be initiated. When an output in the form of an illuminated light is triggered the social interaction device is designed so that the visible light produced can be seen by users within its proximity and, more ideally, the user whose social interaction device caused the light to illuminate. But, as one of reasonable skill in the relevant art will appreciate, the antenna pattern and infrared signals they convey are distinct, though related, from the visible output.

The present invention attempts to provide a means by which users can be informed visually that an individual within their immediate vicinity shares a common interest or preference. While in the example discussed above, the illumination of a green light on the device indicated that a match exists with respect to preferences for vacation, other types of output can be directed. The output could be audible and can vary in volume based on the strength of the signal. Thus as two social interaction devices that share a commonality get closer the volume of an audible signal can increase or its frequency can change. Similarly the frequency of a blinking light can increase as proximity is increased. In other embodiments the variances in an audio signal or the frequency of a blinking light can reflect the degree of commonality. For example, the lights on the social interaction devices associated with two individuals that share a high correlation in an area of interest can blink more frequently than on the devices of two individuals that only possess a small degree of correlation. Similarly, the intensity of the illumination of the light can vary as to signal strength. And while the illustrated embodiment includes three lights of varied color, the device can include more or less lights and can offer different colors. Indeed a red, green, blue lighting source combination can be varied so as to produce any multitude of output colors.

In the example presented above a match was determined and displayed when the system determined that two users fall into the same category of preferences. In another embodiment, the degree of correlation can be indicated for a certain area of interest by the illumination of a number of similarly colored lights. For example the correlation or match list may indicate that two devices only show a match for vacation preferences of 4 on a scale of 1 to 10. While in the prior embodiment, these two devices would not provide any indication of a match, in another embodiment a series of multicolored light emitting diodes may present a range of interest. So when the two interact they may show 4 illuminated green lights. Regardless of the degree of commonality the device acts to initiate and support face-to-face interaction.

According to another embodiment, the correlation lists maintained by each social interaction device are periodically updated. While the actual interaction between devices is controlled by an antenna pattern that supports face-to-face interaction, the actual data the devices uses to determine such a match can be updated wireless via RF, Bluetooth or similar technology. Smart phones can also be used to input and convey such information to the device that can then identify other users in the immediate vicinity that match predefined criteria.

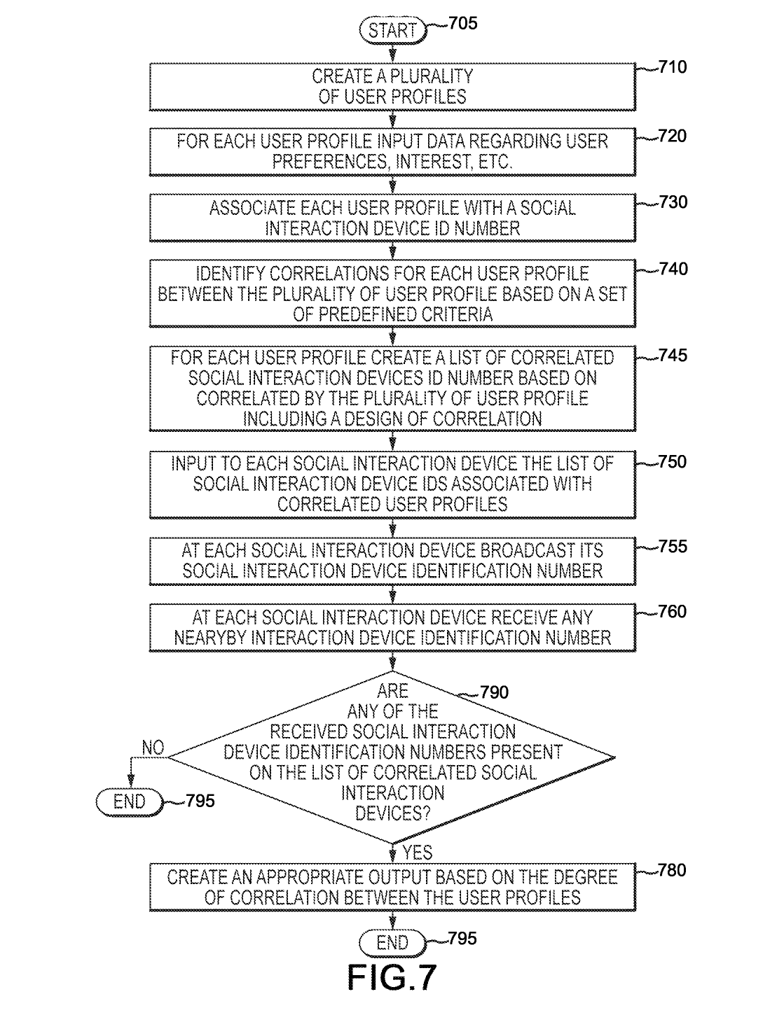

The methodology of the social interaction system of the present invention is show, in one embodiment by the flowchart of FIG. 7. In the following description, it will be understood that each block of the flowchart illustrations, and combinations of blocks in the flowchart illustrations, can be implemented, in part, by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems or firmware that perform the specified functions or steps, or combinations of special purpose hardware and computer instructions.

The process of the present invention begins 705 with the creation of a plurality of user profiles 710. For each user profile, data is gathered 720 with respect to preferences for particular areas of interest. These preferences can be with respect to professional interest or interest of leisure in nature. They can also reflect characteristics of the individual or desired outcomes. The present invention can use and implement a wide variety of preferences and user data to create correlations and matches between user preferences to assist and enhance face-to-face interaction. It is also contemplated that other data sources can be utilized to provide input to a matching/correlation algorithm. For example publicly available information about individuals can be used to construct a profile as can data collected and maintained as the part of existing profiles on other social networks, work profiles, etc. The data with respect to identifying an individuals preferences, likes and dislikes, interests etc. can be obtained from many diverse sources. All of which are contemplated to be within the scope of the present invention.

The process continues by associating 730 each user profile with a specific social interaction device. In one embodiment of the present invention, the social interaction device includes its own identification number. It is important to note that while the server may possess data tying the user to the user's preferences, in this embodiment the data possessed by the social interaction device is limited to a list of matching social interaction device identification numbers. The device itself does not possess any confidential information about the associated users. Similarly, the information being broadcast is again the identification number of a social interaction device. Confidential user information remains secure on an individual server that can be protected by a variety of means as would be known to one skilled in the art of data security.

Once data is collected from each of the plurality of user profiles, a matching or correlating algorithm 740 is run to determine which user preferences match other users preferences. These correlations or matches can be based on one or more predefined sets of criteria that can vary from instance to instance. Once correlations have been determined, a list for each social interaction device is created 745 indicating other social interaction devices that are associated with users that have similar or matching preferences.

The correlation lists, once created, are input 750 to each social interaction device. In one embodiment, these inputs may be accomplished by a serial or USB connection while in other embodiments these inputs can be accomplished wirelessly. And while an initial input is required to initiate the process, in other embodiments, the list can be updated as new users area added to the group or other users exit from the collective.

Once each device is updated with their lists of other matching social interaction devices, the devices are worn or outwardly displayed by the users as they interact in a social setting. Each device broadcasts 755 its social interaction device identification number using, in one embodiment, infrared signals. Other social interaction devices that are within the vicinity of the broadcasting device and within its antenna pattern receive 760 the identification number and determine 790 whether a match exists. If upon examination of the correlation lists stored on the device no match exits the process ends 795. When the examination determines 790 that the identification number of the received social interaction device matches one of the identification numbers on a stored correlation list, a predefined output, such as the illumination of a particular light, is initiated 780.

In another embodiment of the present invention each social interaction device records its interactions with other social interaction devices. This data can thereafter be downloaded to the server and reviewed by the user to reinforce the social interactions that may have taken place. In addition the user, in one embodiment can be informed of the number of matches that the system has determined exist and if during a period of time they interacted with any of the social interaction devices that had been designated as a match.

Another aspect of the present information is to link each social interaction device to a user's smart phone, tablet or the like. Matching profiles can be downloaded to provide each individual with additional information without violating or revealing any private or confidential information. For example, consider the example above in which four individuals all are determined to be matched in the vacation category. In one embodiment, the predefined point criteria was a score from 16-20 points based on two questions. But while it can be assumed generally that each of the users within this range share the same preference for vacation, the details may vary. According to one embodiment of the present invention, the system can provide additional information to assist and encourage social interaction. Turning back to the prior example, assume that the social interaction devices worn by users 4 and 15 are within range of each other and that the two users wearing the devices are oriented so that the device antenna patterns intersect. As previously discussed, both devices will initiate a visual output from the devices to promote face-to-face interaction. In addition, each device can provide additional information regarding the matched category and convey that information via smart phone. For instance, user 4 may have indicated a 10 on a scale of 1-10 that they really prefer to travel abroad and only a 6 regarding the question of being an indoor or outdoor person, indicating they are really neutral regarding that particular preference. By comparison user 15 may have provided a slight preference to travel abroad and a strong preference to be outside when on vacation rather than be indoors. According to one embodiment of the present invention, additional information can be released regarding matched users upon an interaction occurring. Thus, if the users have elected to release such information, when a face-to-face interaction occurs, triggered by the interaction of two matching devices, the server can provide each user with additional information via text, email or other electronic means.

The examples provided above adopt a thin client/server relationship. A server conducts the determination of viable preference matches or correlation while the device itself simply determines whether a received code matches data possessed on a stored list. In another version of the present invention each device operates to determine whether other devices are potential matches. Each device is programmed with the preference data of its associated user. As users interact in a social setting each device broadcasts the social device identification code along with data regarding preferences of that user. For example, the device may broadcast its identification number and a score for the preference of technology, animals, and vacation (referring back to the prior example).

As before each device also receives data from nearby social interaction devices. However, in this case, the received data includes not only a social interaction device identification code but values for the preferences of the user associated with that device. The receiving device then compares its stored values to those received. If the device determines, based on predefined criteria, that a match has occurred, an outwardly visible output is initiated. In this option, each user can, in one embodiment, modify the criteria by which the preference indicates a match has occurred. For example, user 15 may feel so strongly that vacation should involve outdoor activities and abroad that he or she only wants a match to be indicated when the other user scores 18 or above, rather than the typical range of 16-20. Similarly, the user can relax the criteria to provide more flexibility within a specific category to initiate more social contact.

This approach of the present invention requires each device to possess additional memory and processing capability but offers the ability of the devices to be more autonomous and flexible.

The social interaction device system and associated methodology can be used in a variety of settings and address a wide variety of applications. In a social setting, the devices can facilitate overcoming a first communication barrier and promote personal interaction. Social mixers or newcomer orientation meetings can be improved by providing individuals with a means by which to initiate a conversation and explore commonalities.

Similarly, symposiums or professional interactions in which groups of professionals from diverse locations or backgrounds meet from within a particular industry can be enhanced by providing each individual with the ability to identify common preferences or interests on professional topics, as well as social and personal values.

The present invention provides a device and system to encourage face-to-face interaction. By collecting data regarding personal preferences over a wide variety of categories, an analysis can take place to determine users with likely matches in preferences or commonalities in interests. These preference matches can be programmed into a social interaction device worn by the users so that when two devices (users) that share a common preference interact the devices can be triggered to indicate a common interests exists. The device can encourage first contact or simply enhance an ongoing conversation. For example consider a social engagement in which each attendee wears a social interaction button. As the engagement progresses and individuals mingle, the buttons will on occasion light up indicating that the person or persons you are currently engaged in share a common preference or interest that may be unknown to you both. By inspiring further face-to-face interaction, the social interaction device has through the use of electronic data communication, facilitated direct interpersonal communication.

As will be appreciated by the reader, portions of this specification dealing with preference matching are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Also unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

It will be understood by those familiar with the art, that the invention presented herein may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

In a preferred embodiment, portions of the present invention can be implemented in software. Software programming code which embodies the present invention is typically accessed by a microprocessor from long-term, persistent storage media of some type, such as a flash drive or hard drive. The techniques and methods for embodying software programming code in memory, on physical media, and/or distributing software code are well known.

Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A social interaction device, comprising:
a social interaction device identification number;
a transceiver operable to broadcast the social interaction device identification number and to receive other social interaction device identification numbers from other nearby social interaction devices;
an output module;
a micro processor capable of executing instructions; and
a memory operable to store a list of correlated social interaction device identification numbers and a program of instructions executable by the microprocessor wherein said program of instruction comprises a plurality of program codes for identifying social interaction device correlation, said program of instruction including
program code for comparing received other social interaction device identification numbers with the list of correlated social interaction device identification numbers, and
responsive to a determination that one or more received other social interaction device identification numbers is included on the list of correlated social interaction device identification numbers, program code for directing the output module to create an output.

2. The social interaction device of claim 1, wherein the transceiver broadcasts and receives using an infrared signal.

3. The social interaction device of claim 1, wherein the transceiver is limited to line-of-sight communications.

4. The social interaction device of claim 1, wherein the list of correlated social interaction device identification numbers includes a degree of user profile correlation.

5. The social interaction device of claim 1, wherein the output includes illuminating one or more lights.

6. The social interaction device of claim 5, wherein the output is based on a degree of user correlation.

7. The social interaction device of claim 1, further comprising program code for receiving updates to the list of correlated social interaction device identification numbers.

8. The social interaction device of claim 1, further comprising program code for storing in the memory a list of received other social interaction device identification numbers that were included on the list of correlated social interaction device identification numbers.

9. A social interaction system, comprising:
a plurality of user profiles wherein each of the plurality of user profiles is associated with a unique social interaction device identification number;
a server operable to receive the plurality of user profiles, identify a degree of user profile correlation, and create for each user profile a list of correlated social interaction device identification numbers; and
a plurality of social interaction devices wherein each social interaction device is associated with one unique social interaction device identification number and includes the list of correlated social interaction device identification numbers, and, upon identifying its proximity with another social interaction device on the list of correlated social interaction device numbers, initiate a predefined output.

10. The social interaction system of claim 9, wherein each user profile includes information regarding individual characteristics and preferences.

11. The social interaction system of claim 9, wherein the list of correlated social interaction device identification numbers includes for each social interaction device identification number the degree of user profile correlation.

12. The social interaction system of claim 11, wherein the predefined output differs based on the degree of user profile correlation.

13. The social interaction system of claim 9, wherein each social interaction device includes a transceiver.

14. The social interaction system of claim 13, wherein the transceiver includes a limited field of view.

15. The social interaction system of claim 13, wherein the transceiver broadcasts and receives social interaction device identification numbers using infrared signals.

16. A method for enhancing social interaction, the method comprising:
creating a plurality of user profiles;
associating each user profile with a social interaction device;
identifying correlations between other of the plurality of user profiles based on a predefined set of criteria;
responsive to being within a proximity of another social interaction device associated with a correlated user profile, initiating an observable output.

17. The method for enhancing social interaction according to claim 16, further comprising creating, for each of the plurality of user profiles, a unique list of correlated social interaction device identification numbers based on identified correlations between the plurality of user profiles.

18. The method for enhancing social interaction according to claim 17, further comprising storing on each social interaction device the unique list of correlated social interaction device identification numbers.

19. The method for enhancing social interaction according to claim 18, further comprising broadcasting, by each social interaction device, its social interaction device identification number.

20. The method for enhancing social interaction according to claim 19, further comprising receiving broadcast social interaction device identification numbers.

21. The method for enhancing social interaction according to claim 20, wherein initiating the observable output is responsive to determining that a received broadcast social interaction device identification number is included on the unique list of correlated social interaction device identification numbers.

22. The method for enhancing social interaction according to claim 20, wherein each of the plurality of user profiles includes user preferences.

23. The method for enhancing social interaction according to claim 19, wherein broadcasting includes using line-of-sight communication signals.

24. The method for enhancing social interaction according to claim 16, wherein the observable output is based on a degree of correlation.

25. The method for enhancing social interaction according to claim 16, wherein the observable output is illumination of one or more lights.

26. The method for enhancing social interaction according to claim 16, wherein the observable output is auditory.

27. The method for enhancing social interaction according to claim 16, wherein associating includes loading associated user profile data on the social interaction device.

28. The method for enhancing social interaction according to claim 27, further comprising broadcasting, by each social interaction device, associated user profile data.

29. The method for enhancing social interaction according to claim 28, further comprising receiving broadcast user profile data.

30. The method for enhancing social interaction according to claim 29, further comprising determining, by the social interaction device, correlations between the user profile associated with the social interaction device and received broadcast user profile data.

31. A system for social interaction comprising a plurality of social interaction devices wherein each device is associated with a user profile and each is operable to initiate an observable output upon determination of being proximate with another device whose associated user profile shares a predefined degree of correlation.
